(19) United States
(12) Patent Application Publication
(10) Pub. No.: US 2003/0204368 A1
(43) Pub. Date: Oct. 30, 2003

(54) Adaptive sequential detection network

(76) Inventors: Emre Ertin, Lewis Center, OH (US); Kevin L. Priddy, Dayton, OH (US)

Correspondence Address: Killworth, Gottman, Hagan & Schaeff, L.L.P., One Dayton Centre, Suite 500, Dayton, OH, 45402-2023, US

(21) Appl. No.: 10/397,971

(22) Filed: Mar. 26, 2003

Related U.S. Application Data
(60) Provisional application No. 60/368,947, filed on Mar. 29, 2002.

(51) Int. Cl. G06F 15/00; G06F 17/18; G06F 101/14

(52) U.S. Cl. 702/179

(57) ABSTRACT

Sequential detection networks are provided that do not rely on statistical models for the source statistics such as source conditional density functions. Further, the present invention provides sequential detection networks that are adaptive to on-line changes in the source statistics and are thus applicable to the analysis of dynamic problems including those with complex density functions. The present invention also provides sequential detection networks that can automatically make a decision to either accept a next data sample or make a classification decision based upon cost determinations. Still further, the present invention provides sequential detection networks that can automatically make decisions on the order of sampling from a given set of data streams.

### CROSS REFERENCE TO RELATED APPLICATIONS

This application claims priority to U.S. Provisional Patent Application Serial No. 60/368,947 filed Mar. 29, 2002; the disclosure of which is hereby incorporated by reference.

### BACKGROUND OF THE INVENTION

The present invention relates in general to sequential detection networks and in particular to sequential detection networks that do not rely on predetermined statistical models to perform sequential tests. The present invention further relates to sequential detection networks that can adapt to on-line changes in source statistics.

In many signal processing applications including classical hypothesis testing and traditional machine learning, a detector is provided that has access to a fixed number of observations from which the detector draws inferences about a prevailing hypothesis. For example, a classifier may be trained using a fixed number of pre-classified (labeled) data objects. The trained classifier is then evaluated using a fixed number of pre-classified evaluation data objects. Upon completion of the evaluation process, a performance measure can be computed for example, to determine the accuracy of the classifier in correctly assessing the pre-classified evaluation data objects. Common to the above-mentioned signal processing applications is the fact that the analysis is performed, and conclusions are drawn only after all of the labeled data has been collected.

An alternative to the fixed observation approach is to perform sequential testing. The basic idea of sequential testing is to fix a desired performance level, and vary the number of observations such that the desired performance level is achieved with the minimal number of observations. Sequential testing advantageously allows each observation to be analyzed directly after being collected. The current observation and prior collected observations are then suitably processed and collectively compared with threshold criteria to determine for example, whether the desired performance level has been realized. Most importantly, sequential testing allows conclusions to be drawn during the collection of observations.

Sequential tests on average provide substantial savings over classical hypothesis testing in terms of the number of samples or observances required to perform a test with a given level of performance, and are thus desirable when minimizing the cost of taking additional observations given predetermined performance constraints. Sequential tests are also particularly useful in applications in which large numbers of identical tests are to be performed, or where a large volume of real time sensor data must be accessed for performing multiple hypothesis tests with constraints on computational resources. For example, sequential detection theory is applicable to a number of signal processing, sensor processing, control, medical, and communications applications including radar signal processing, and automated target recognition.

As one example, sequential tests with repeated experimentation (data collection) are applicable to target recognition systems to minimize target acquisition time for a given set of error probabilities. In automated target recognition systems, a plurality of features (detection statistics) are computed by extracting measurements from images such as digital representations of radar signals. The computation of each feature imposes a specific, and often significant computational load on the system. Sequential testing provides an approach to address the high data rates and real-time processing requirements for target recognition systems, including wide area surveillance recognition systems, by enabling a staged decision strategy approach. Each stage of the system computes discrimination statistics to reduce false alarms while maintaining a high probability of detection. Further, the screening of false alarms reduces the data rate faced by subsequent stages.

There are important aspects however, that limit the usefulness of sequential tests for many applications. The design of a sequential detector system requires an exact knowledge of the conditional density functions for the observations. For example, a particular application of a sequential detection network may require the underlying source statistics to have as the conditional density function, a Gaussian density with specified mean and variance, an exponential density with specified mean, a uniform density function with specified support, or any other precisely specified known density functions. Even for relatively simple problems such as constant signal detection in Gaussian noise, the form of the sequential detector depends on the mean of the conditional distributions. As a result of the dependency of sequential detectors on exact conditional distributions, sequential tests are not robust to variations in observation statistics. Unfortunately, the underlying statistics of many real-life problems cannot be modeled by predetermined, known conditional density functions, limiting the applicability of sequential detection systems. For example, radar routinely exhibits multicluster, multidimensional density functions. Also, some density functions change over periods of time.

### SUMMARY OF THE INVENTION

The present invention overcomes the disadvantages of previously known sequential detection networks by providing nonparametric sequential detection networks that do not rely on statistical models for the source statistics such as source conditional density functions. Further, the present invention provides sequential detection networks that are adaptive to on-line changes in the source statistics and are thus applicable to the analysis of dynamic problems including those with complex density functions. The present invention also provides sequential detection networks that can automatically make a decision to either accept a next data sample or make a classification decision based upon cost considerations. Still further, the present invention provides sequential detection networks that can automatically make decisions on the order of sampling from a given set of data streams.

A method of determining a posterior probability according to one embodiment of the present invention comprises processing each sample of a data set sequentially by performing at least one likelihood computation based upon the sample. The likelihood computations are accumulated and the posterior probability estimate is computed based upon the accumulation of the likelihood computations.

A system for determining a posterior probability according to another embodiment of the present invention comprises a posterior probability estimator arranged to analyze samples from a data set in a sequential manner, and generate an estimated posterior probability based upon an accumulation of likelihood determinations computed for each sample considered.

A detector for sequential analysis according to another embodiment of the present invention comprises a posteriori probability estimator arranged to analyze labeled data samples sequentially and compute an estimated posterior probability by computing for each labeled data sample received, a probability that a source phenomenon of interest described by the labeled data samples belongs to a first class, the probability computed without reliance on a predetermined statistical distribution of the source phenomenon of interest.

An adaptive detector for sequential data analysis systems according to yet another embodiment of the present invention comprises a first neural network having at least one input node, at least one hidden layer, at least one linear output and a logistic output. Each hidden layer is arranged to implement a nonlinear function and is communicably coupled to at least one input node. Each linear output is communicably coupled to at least one hidden layer and is configured to output a likelihood computation and compute an accumulation of respective previous likelihood computations. The logistic output is communicably coupled to each linear output and is arranged to transform the accumulations of the likelihood computations into a sigmoid output.

A method of performing adaptive sequential data analysis on a labeled data set according to yet another embodiment of the present invention comprises sequentially accessing a labeled data sample. For each labeled data sample, a posterior probability is calculated, and a first cost associated with making a classification decision in view of the risk of an error in classification given the posterior probability is determined. A second cost associated with collecting another labeled data sample is also determined before making a classification decision where the second cost is based at least in part upon the posterior probability. The first and second costs are compared against a predetermined stopping criterion, each of the above steps are repeated if the results of the comparison suggest taking another labeled data sample. If the comparison suggests stopping however, a predetermined action is performed.

An adaptive sequential data analysis system according to yet another embodiment of the present invention comprises a posterior probability estimator arranged to access the labeled data set sequentially, and compute therefrom, an estimated posterior probability. A cost of decision estimator is communicably coupled to the posterior probability estimator and is arranged to determine a first cost associated with making a classification decision in view of the risk of an error in classification given the posterior probability. A cost to go estimator is communicably coupled to the posterior probability estimator and is arranged to determine a second cost associated with collecting another labeled data sample before making a classification decision where the second cost is based, at least in part, upon the posterior probability. A decision processor is communicably coupled to the cost of decision estimator and the cost to go estimator. The decision processor is arranged to compare the first and second costs against a predetermined stopping criterion, wherein the decision processor is configured to trigger a predetermined action based upon the comparison.

A method of automatically making a decision on the order of sampling from a given set of data streams according to yet another embodiment of the present invention comprises sequentially accessing a labeled data sample. For each labeled data sample, a posterior probability is computed and a first cost is determined. The first cost is associated with making a classification decision in view of the risk of an error in classification given the posterior probability for each feature of a plurality of features. A second cost associated with collecting another labeled data sample is determined before making a classification decision. The second cost is based, at least in part, upon the posterior probability. A data stream is chosen by comparing at least two of the first costs associated with respective features and selecting one stream associated with a selected one of the features based upon the comparison of the first costs, and comparing the first cost associated with the selected stream and the second cost against a predetermined stopping criterion. Each of the above steps is automatically repeated if the results of the comparison suggest taking another labeled data sample, and a predetermined action is performed if the results of the comparison suggest stopping.

A sequential detector capable of analyzing multiple streams according to yet another embodiment of the present invention comprises a posterior probability estimator arranged to access a labeled data set sequentially and compute therefrom, an estimated posterior probability. The detector also comprises a plurality of cost of decision estimators, each communicably coupled to the posterior probability estimator. Each of the cost of decision estimators is arranged to determine a first cost associated with making a classification decision in view of the risk of an error in classification given the posterior probability for a select one of a plurality of features.

The detector further comprises a cost to go estimator communicably coupled to the posterior probability estimator. The cost to go estimator is arranged to determine a second cost associated with collecting another labeled data sample before making a classification decision. The second cost is based, at least in part, upon the posterior probability. The detector also comprises a decision processor communicably coupled to each of the cost of decision estimators and the cost to go estimator. The decision processor is arranged to choose a data stream by comparing at least two of the first costs associated with respective features and selecting one stream associated with a selected one of the features based upon the comparison of the at least two of the first costs, and compare the first cost associated with the stream and the second cost against a predetermined stopping criterion.

It is an object of the present invention to provide sequential detection networks and methods for nonparametric data analysis.

It is an object of the present invention to provide sequential networks and methods that can learn from the source data without reliance on underlying statistical models.

It is an object of the present invention to provide sequential networks and methods that can adapt to on-line changes in the source statistics.

It is an object of the present invention to provide learning methods to train sequential detection networks through reinforcement learning and cross-entropy minimization on labeled data.

Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is an illustration of a detector for an adaptive sequential detection system according to one embodiment of the present invention;

FIG. 2 is an illustration of a feed forward neural network used to implement a posterior probability estimator according to one embodiment of the present invention;

FIG. 3 is an illustration of a feed forward neural network used to implement a posterior probability estimator according to another embodiment of the present invention;

FIG. 4 is an illustration of a feed forward neural network used to implement a posterior probability estimator according to yet another embodiment of the present invention;

FIG. 5 is an illustration of a detector for an adaptive sequential detection system according to another embodiment of the present invention;

FIG. 6 is a graph illustrating distributions used to test the effectiveness of one embodiment of the present invention;

FIG. 7 is a graph illustrating the estimated versus actual distributions for a test according to one embodiment of the present invention;

FIG. 8 is a graph illustrating estimated versus actual costs for a test according to one embodiment of the present invention; and,

FIG. 9 is an illustration of a detector for an adaptive sequential detection system according to yet another embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that logical, mechanical, and electrical changes may be made without departing from the spirit and scope of the present invention.

Sequential Detection Networks

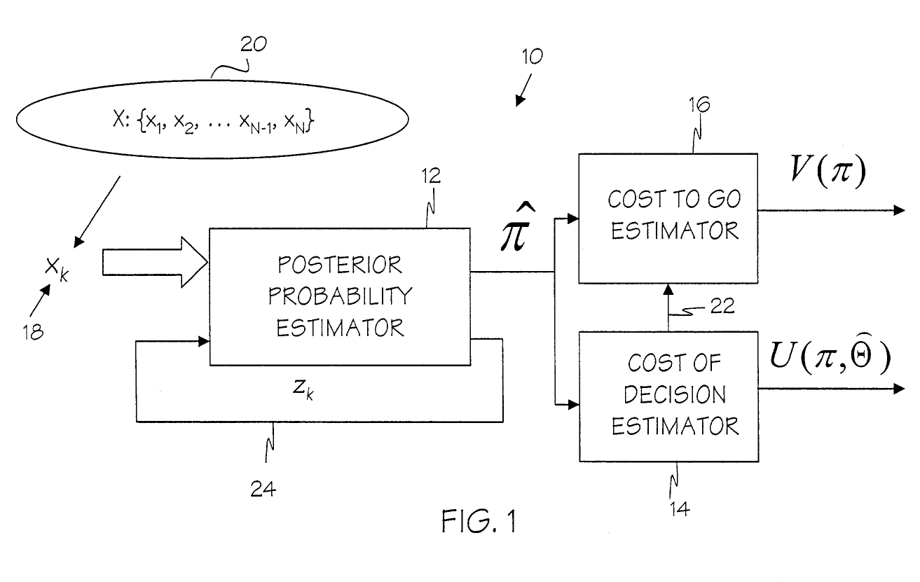

FIG. 1 illustrates a detector 10 according to one embodiment of the present invention. The detector 10 can be implemented as part of a larger sequential data analysis system to construct classifiers or perform any number of other sequential data analysis tasks. As shown, the detector 10 comprises a posterior probability estimator 12 communicably coupled to a cost of decision estimator 14, and a cost to go estimator 16. The detector 10 sequentially processes labeled data 18 (also referred to herein as samples or observations) from a labeled data set 20 until a predetermined stopping criterion is met. Once the stopping criterion is met, additional processing can be performed, such as making a final classification decision.

The detector 10 sequentially analyzes labeled data 18 from the labeled data set 20 to provide meaningful results in an adaptive, nonparametric approach to sequential testing that does not require knowledge of previously determined statistics regarding the data set 20. As used herein, the labeled data 18 is expressed as xₖ and represents the k^{th} observation from an observation sequence of length N, X_{N} (1 k N). The labeled data set 20 typically comprises pre-classified data that is reasonably representative of the type of data that the sequential data analysis system will manipulate.

The Posterior Probability Estimator

The posterior probability estimator 12 is configured to compute posterior probability estimates \hat{π} given an input comprising the labeled data 18 in view of M possible classes (states of nature) Θ={θ₀, θ₁ . . . θ_{M-1}}. The posterior probability is expressed in a posteriori probability space having M−1 dimensions, and provides the detector 10 with a measure of the likelihood that a source phenomenon of interest being tested belongs to a particular class.

The posterior probability estimator 12 may compute the posterior probability estimate \hat{π} in any practical manner. However, one approach to constructing the posterior probability estimator 12 takes advantage of an observation that the output functions of multilayer perceptron (MLP) neural networks can be configured to approximate Bayes optimal discriminant functions, at least in the minimum mean squared-error sense. When an MLP is configured to produce a logistic output (or generalization of a logistic output) and is trained during reinforcement learning for example, by utilizing a negative log-likelihood error measure (cross-entropy), the MLP models a nonlinear logistic regression or posterior probability having a nonlinear decision boundary. Accordingly, it is possible to set sensible decision thresholds for the MLP output, and use that output to represent approximate a posteriori probabilities for making classification decisions.

One benefit of this approach is that the MLP can be used to approximate posterior probabilities for two class problems as well as multiple class problems. This is accomplished for the special case of two classes (Θ=θ₀, θ₁) by computing for each successively considered labeled data 18, a logistic function that describes a likelihood that the labeled data 18 belongs to a select one of class θ₀ and class θ₁. For the multi-class case (Θ=θ₀, θ₁ . . . θ_{M-1}), an output is computed in the M−1 dimensional space that comprises a generalization of the logistic function. The present invention provides a modification to the MLP that allows an accumulation of likelihood determinations during sequential testing in a manner that avoids the need to necessarily comprehend the exact statistical distribution for the data being analyzed a priori. It shall be appreciated that the method of accumulating likelihoods as described herein is not limited to implementation of classification networks using MLPs. Rather, the accumulation of likelihoods can be implemented on networks such as Radial Basis Function Networks, on any number of kernel-based methods, on support vector machines, and in other processing environments.

The posterior probability estimator 12 according to one embodiment of the present invention may be implemented as a first neural network operating as a first universal approximator. While a feedforward network architecture may be used to implement the posterior probability estimator 12, an optional feedback path 24 is illustrated to suggest that other neural network models are also possible, such as recurrent neural networks. The exact implementation of the posterior probability estimator 12 will depend upon a number of factors including the nature of the data to be analyzed.

As an example, assume that there are two possible classes (states of nature) Θ={θ₀, θ₁}. Given this constraint, the posteriori space will have only one dimension. The goal is to analyze a source phenomenon of interest and categorize that source phenomenon as belonging to either class θ₀ or to class θ₁.

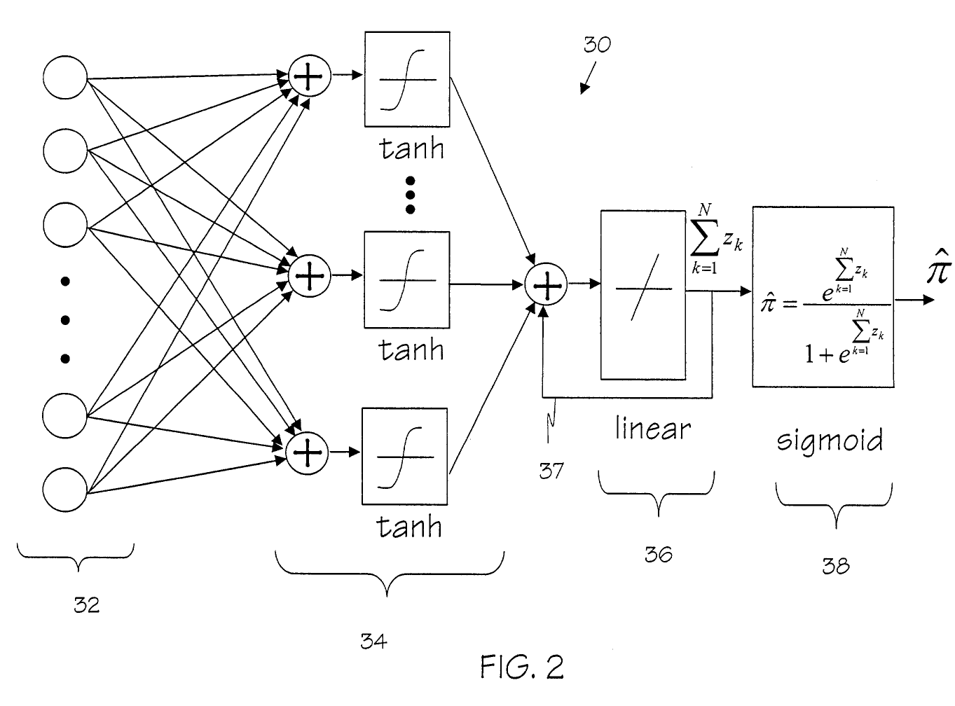

Referring to FIG. 2, a first neural network 30 for the above two-class problem is implemented as a feedforward neural network having at least one input 32, at least one hidden layer 34, and an output 36. As illustrated, the first neural network 30 comprises a single hidden layer 34 that utilizes a hyperbolic tangent (tanh) activation. Other activations and additional hidden layers may be used as the specific application dictates. The output layer 36 generates a linear output function that represents the likelihood that the data object being tested belongs to class θ₁. It will be appreciated that this construction, a nonlinear hidden layer 34 combined with a linear output layer 36, provides a flexible architecture that allows the first neural network 30 to learn nonlinear as well as linear relationships between the input and output vectors. The linear output 36 is accumulated via a feedback path 37. The linear output 36 is further transformed into a sigmoid (logistic) output 38 that comprises the accumulation of likelihoods for class θ₁. The sigmoid output 38 provides an approximation of the posterior probability \hat{π} for class θ₁, and is given by:

$$\hat{π} = \frac{{ⅇ}^{{\sum }_{k = 1}^{N} {z}_{k}}}{1 + {ⅇ}^{{\sum }_{k = 1}^{N} {z}_{k}}}$$

As used herein, zₖ=g(xₖ) and represents the kth output of the feedforward neural network. N is a random variable suggesting that there is a set of N observations (X_{N}ε [symbol] ^{N}) for a given application. According to one embodiment of the present invention, the structure of the first neural network 30 allows for the interpretation of the neural network output zₖ as a log-likelihood for class θ₁, and is expressed as:

$${z}_{k} = g ( {x}_{k} ) \approx log ( \frac{f ( {x}_{k} \vert {θ}_{1} )}{f ( {x}_{k} \vert {θ}_{0} )} ) .$$

It will be appreciated that the above log expression represents the natural log. The computation of log-likelihoods for class θ₁ provides a probability estimate that the data object being tested belongs to class θ₁. The sigmoid output 38 comprises the accumulation of the log-likelihoods for class θ₁ and describes a conditional density distribution. This construction eliminates the need to know the exact statistics of the labeled data.

A priori, one class can be more probable than the others. This prior bias in data can be handled easily by manipulating the soft-max function. Assume that the a priori probability of class θ₁ is p, then the soft-max function can be modified as:

$$\hat{π} = \frac{L {ⅇ}^{{\sum }_{k = 1}^{N} {z}_{k} - N log L}}{1 + L {ⅇ}^{{\sum }_{k = 1}^{N} {z}_{k} - N log L}}$$

In the above equation, L=p/(1−p). It shall be appreciated that if the prior probabilities are not known, they can be easily estimated from labeled data by calculating the frequency of each class.

According to one embodiment of the present invention, the feedforward network function g(x) is trained using a cross-entropy criteria as labeled data becomes available during the reinforcement learning process of the sequential test. Other training methods may also be used within the spirit of the present invention so long as the MLP output approximates Bayesian a posteriori probabilities. For example, although not a perfect error measure, the squared error cost functions may be used to train the MLP in certain applications. Further, various scaling and equalization techniques may be employed to account for deficiencies in the underlying labeled training data. For example, scaling and equalization may be applied where the frequency of certain classes in the labeled data set vary significantly between classes sufficient to introduce a bias towards predicting the more common classes.

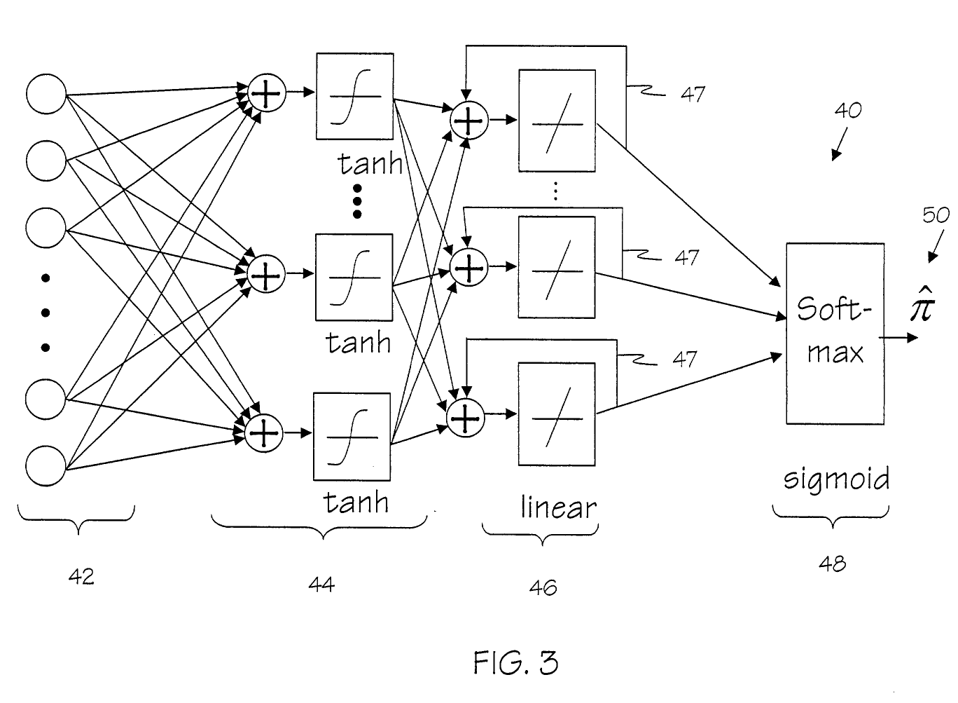

A posterior probability estimator for a multiclass problem according to another embodiment of the present invention is illustrated in FIG. 3. The posterior probability estimator comprises a first neural network 40 operating as a first universal approximator configured to address a multi-class (multiple hypothesis) problem. As an example, assume that there are M possible classes (states of nature) (Θ=θ₀, θ₁ . . . θ_{M-1}). Given this constraint, the posteriori space has M−1 dimensions. The goal is to analyze a source phenomenon of interest and categorize that source phenomenon as belonging to a select one of the M classes. The first neural network 40 is implemented as a feedforward neural network having at least one input 42, at least one hidden layer 44, M−1 linear outputs 46, and a sigmoid output 48 that defines a posterior probability output 50.

As illustrated, the first neural network 40 comprises a single hidden layer 44 that utilizes a tanh activation. As with the previous example, other activations and additional hidden layers may be used as the specific application dictates. There are M−1 linear outputs 46, one linear output 46 to represent each dimension in the posteriori space. Each linear output 46 comprises a likelihood computation, and is accumulated via feedback paths 47. The linear outputs 46 are transformed into a sigmoid output 48 that comprises an accumulation of the computed likelihoods. For example, a soft-max function may be implemented to provide an estimated posterior probability output 50 that represents posterior probability estimates \hat{π} for the M−1 space. The posterior probability output 50 is also sometimes referred to as a generalized logistic output. According to one embodiment of the present invention, the posterior probability estimate \hat{π}ᵢ for class i (where i is chosen between 1 and M−1) is given by:

$${\hat{π}}_{i} = \frac{{ⅇ}^{\sum {z}_{k}^{i}}}{1 + {\sum }_{m = 1}^{M - 1} {ⅇ}^{\sum {z}_{k}^{m}}}$$

Similar to the two-class case above, the variable zₖ^{m} according to one embodiment of the present invention represents the output of the m'th network that approximates the log-likelihood of the m'th class. The log-likelihood computations are given by:

$${z}_{k}^{m} = {g}^{m} ( {x}_{k} ) \approx log ( \frac{f ( {x}_{k} \vert {θ}_{m} )}{f ( {x}_{k} \vert {θ}_{0} )} )$$

As with the two-class problem, this construction eliminates the need to know the exact statistics of the labeled data. It shall be appreciated, as in two class case, prior probabilities can be incorporated to the soft-max function.

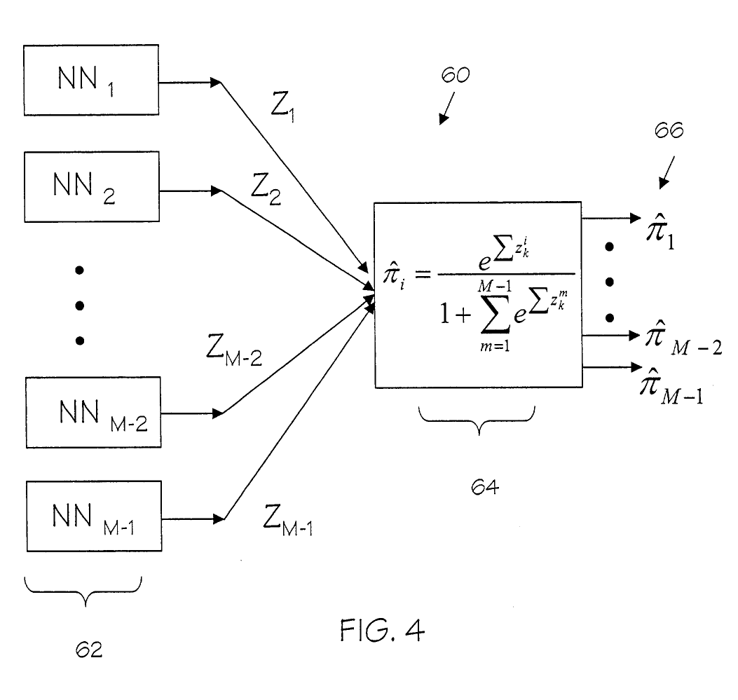

Referring to FIG. 4, an implementation of a posterior probability estimator for a multiclass problem according to another embodiment of the present invention comprises a plurality of feedforward neural 60 operating together to compute a soft-max function. For a problem having M classes (Θ=θ₀, θ₁ . . . θ_{M-1}), there are M−1 feedforward neural networks 62, each having a linear output function, trained using a cross-entropy criteria as labeled data becomes available during the reinforcement learning process of the sequential test. It shall be appreciated that only M−1 outputs are required because the M^{th} output can be stated as 1-(the sum of M−1 outputs). The output of each feedforward neural network 62 is combined into a sigmoid output 64 using for example, a soft-max function and includes an accumulation of log-likelihoods as explained more fully herein. A posterior probability estimate 66 is thus computed for each neural network in a manner that eliminates the need to know the exact statistics of the labeled data. The soft-max function produces an estimated posterior probability output 66 that represents posterior probability estimates \hat{π}ᵢ for the M−1 space. The estimated posterior probability output 66 is given by the same formula expressed herein for the estimated posterior probability for the multi-class case.

The Cost of Decision Estimator

Referring back to FIG. 1, the cost of decision estimator 14 computes a cost of decision function. The cost of decision estimator 14 looks to balance the likelihood of proper classification with the risk of a mistake in classification by factoring in a weighting value to the likelihood that a data object will be improperly classified if the system stops and does not take another sample. The cost of decision according to one embodiment of the present invention, denoted U(π, \hat{θ}) is expressed by:

U(πₖ,\hat{θ})=(1−γ_{U})U(πₖ,\hat{θ})+γ_{U}L(\hat{θ},θ)

In the above equation, L(\hat{θ},θ) denotes a loss function. The loss function is expressed as L:A×Θ→ [symbol] where A is the final set of decisions {a₁, a₂. . . a_{M-1}, a_{M}}. The term γᵤ is a measure of how fast the sequential data analysis system is trying to learn as compared with the amount of information already learned. The cost of decision function describes the expected decision cost of deciding in favor of a specific class (\hat{θ}) given that the cost of deciding the posterior probability for that specific class is π. This can be seen by way of an example.

For a two-class problem, assume that the approximate posterior probability is described by values ranging from 0 to 1, where 0 represents class θ₀, and the value 1 represents class θ₁. A computed value of 0.5 lies in the middle and generally represents the worst case because the computed value is equidistant between class θ₀ and class θ₁. The closer an estimated posterior probability is to 0, the more likely that a data object being classified belongs to class 0. Likewise, the closer the posterior probability is to 1, the more likely the data object being classified belongs to class 1. It will be appreciated that the selection of range from 0 to 1 is only meant to be exemplary and to facilitate a discussion herein. It is a convenient range of values to use because the posterior probability estimator may be implemented as a neural network having a sigmoid output, and sigmoid outputs are bounded by values of 0 and 1. Other ranges are possible within the spirit of the present invention however.

Assume for example, that after collecting a number of observations, the estimated posterior probability is 0.7. Further, assume that the estimated posterior probability value of 0.7 would result in a classification decision electing class θ₁. The sequential data analysis system can opt to stop processing based upon the evidence collected thus far, and make a final classification decision. Here, the data object being tested would be classified as belonging to class θ₁. However, there is a 0.3 probability that the sequential data analysis system will improperly classify the data object as belonging to class θ₁. The cost of decision estimator 14 looks to balance the likelihood of proper classification with the risk of a mistake in classification by factoring in a weighting value to the likelihood that the data object will be improperly classified if the system stops and does not take another sample. In the above example, a cost can be calculated for example, by multiplying the probability that the sequential data analysis system will improperly classify the data by a weighting factor, that is, multiply 0.3 by a weight.

The cost of decision estimator 14 may be implemented using any number processing techniques. For example, the cost of decision processor 14 may be implemented as a neural network, or a Radial Basis Function network. Further, any number of other kernel methods may be used to implement the cost of decision estimator 14. Also, the cost of decision estimator 14 can be implemented by a lookup table. For example, a lookup table can be constructed that is updated periodically, such as every time the detector 10 decides to stop an make a decision. This approach may require averaging and otherwise manipulating costs in the table when a posterior probability estimate comprises a value that is not directly represented in the table. Further, tables may be of limited appeal for higher dimensionality applications such as multiclass problems. The neural network approach on the other hand, can essentially implement a table and provides a convenient means to fill in the gaps between previously considered posterior probability estimates. Further, the neural network approach can adapt to handle higher dimensionality problems.

According to one embodiment of the present invention, the cost of decision estimator 14 is implemented as a second neural network operating as a second universal approximator. The second neural network is trained using reinforcement learning algorithms. It will be appreciated that any number of known reinforcement learning algorithms may be used, such as value iteration, dynamic programming (synchronous and asynchronous), policy iterations, temporal difference learning, adaptive-critic learning, and Q-learning. However, the second neural network preferably implements an on-policy version of the Q-learning algorithm. It will be appreciated that modifications to the boundary conditions for the Q-learning algorithm may be necessary for two-class and multi-class applications.

The Cost to Go Estimator

The cost to go estimator 16 computes a cost to go function that explores the cost to take another sample against the chance that the estimated posterior probability will tend towards a more ambiguous value. The cost to go function according to one embodiment of the present invention is denoted V(π), and is expressed by:

V(πₖ)=(1−γ_{V})V(πₖ)+γ_{V} min{c+V(πₖ₊₁), U(πₖ₊₁,\hat{θ}*)}

It shall be appreciated that πₖ₊₁ can be created for example, from πₖ by simulation according to the transition probabilities dictated by sample statistics. Let c define a cost function c:Λ×Θ→ [symbol] where Λ defines a state space.

The cost to go function V(π) is the expected cost-to-go given the posterior probability for class θ₁ is π. Continuing on with the above example, assume the approximate posterior probability has a current value of 0.7. The detector 10 must decide whether to stop and make a final decision, or collect another observation. That new observation if collected can improve the convergence of the posterior probability towards a particular class. There is a risk however, that the new observation can move the estimated posterior probability towards a more ambiguous value. For example, assume that after taking one additional sample, the approximate posterior probability is 0.65. Here the posterior probability has moved away from both class θ₀ and class θ₁ and is thus more ambiguous because of the new sample. On the other hand, the approximate posterior probability may continue to converge toward either one of the classes. For example, the approximate posterior probability after processing the next observation may improve to 0.75.

As with the cost of decision estimator 14, the cost to go estimator 16 may be implemented using any number of techniques such as neural networks, tables, Radial Basis Functions, and any number of other kernel methods. However, the cost to go estimator 16 according to one embodiment of the present invention is implemented as a third neural network operating as a third universal approximator. The third neural network is trained for example, using reinforcement learning algorithms, and preferably implements an on-policy version of the Q-learning algorithm. Also, as shown in FIG. 1, a communication path 22 couples the cost of decision estimator 14 to the cost to go estimator 16. This is an optional communication path 22 however, it allows the computation of the cost-to-go function by the cost to go estimator 16 to consider the computed cost of decision function computed by the cost of decision estimator 14.

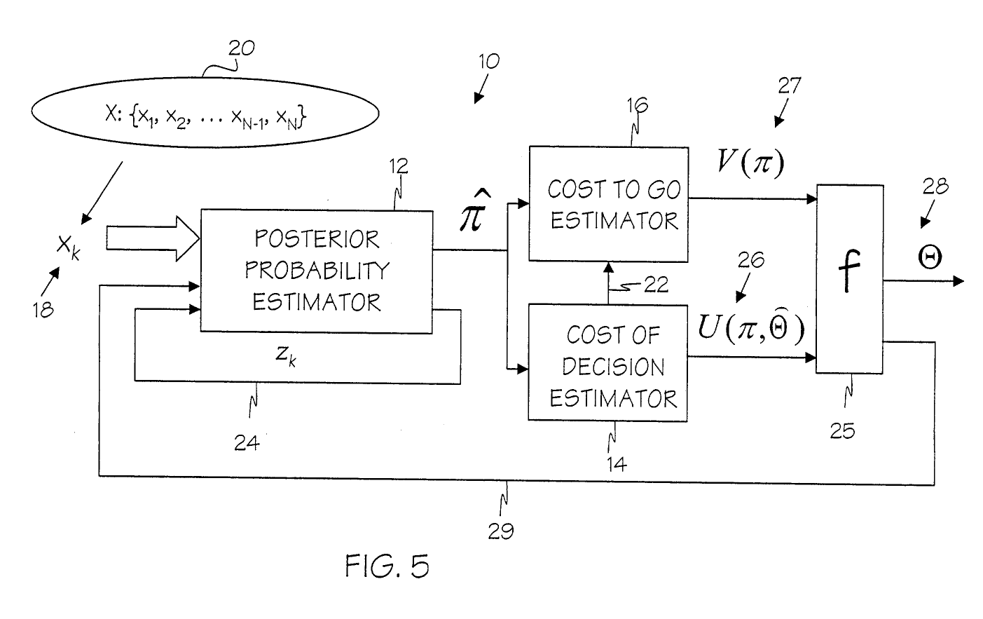

According to one embodiment of the present invention, the detector 10 processes samples sequentially until a predetermined stopping criterion is met. The predetermined stopping criterion may include for example, a user action or a determination that the approximated posterior probability is not significantly changing statistically. Referring to FIG. 5, the detector 10 may further include a decision processor 25 that determines when the stopping criterion is met. For example, the decision processor 25 may signal or trigger the detector 10 to stop taking new samples and/or take an action or make a decision, such as make a classification decision. According to one embodiment of the present invention, the decision processor 25 signals the detector 10 to make a classification decision when the cost to go function 26 is greater than the cost of decision function 27. That is, the classification decision is made when the following condition is satisfied.

V(π)>U(π,\hat{θ})

Basically, this condition establishes that the cost to take another sample in light of the chance that the posterior probability will tend towards a more ambiguous value is outweighed by the likelihood of proper classification, even when considering the risk of a mistake in classification. When the decision processor 25 stops the detector 10, a final action can be taken. For example, in classification applications, the detector 10 can output a classification decision 28. The decision processor 25 may also include feedback 29 or any other necessary communication arrangement if the posterior probability estimator 12 requires instructions to stop sequentially taking samples.

According to an embodiment of the present invention, both the cost of decision estimator 14 and the cost to go estimator 16 are implemented as neural networks that act essentially as tables to provide cost functions for decision making. The respective cost functions are updated periodically during processing to improve classification decisions. For example, after the detector 10 decides to stop taking samples and make a classification decision, either or both the cost of decision estimator 14 and the cost to go estimator 16 may be updated based upon the posterior probability estimate and/or the results of the classification decision made.

If the detector 10 stops collecting samples and makes a bad classification decision, one or both of the cost functions can be updated to reflect that bad decision. Likewise, one or both of the respective cost functions can be updated based upon a good classification decision. This approach allows the detector 10 to continue to refine the cost functions and thus refine classification performance. Accordingly, the cost of decision estimator 14 as well as the cost to go estimator 16 can adapt dynamically to the sample data. Further, the updating of cost functions for both the cost of decision estimator 14 and the cost to go estimator 16 are not dependent upon a predetermined distributions or predetermined values. Rather, the respective cost functions can adapt to the source sample data. This approach is preferably implemented with an embodiment of the detector 10 that can automatically make decisions to stop sampling, or to continue to sample, and to adapt and improve itself based upon those automatic decisions.

According to a further embodiment of the present invention, it can be observed that in certain environments, stopping the detector 10 based solely on the condition that the cost to go function is less than the cost of decision function may produce unsatisfactory results. This is because strict adherence to the greedy action can result in the premature termination of processing. For example, in order for Q-learning to perform satisfactorily, all parts of the posterior probability space should be explored. However, it may be the case that the sequential tests do not operate on the extremes of the probability space. An improved approach is to occasionally choose a random function to test the hypothesis that the greedy action made a good choice in stopping the detector 10. The updates to the cost-to-go and cost-of-decision functions will determine the accurateness of the greedy actions.

For example, a Q-learning reinforcement learning algorithm that may be applied to both the cost of decision estimator 14 as well as the cost to go estimator 16, according to one embodiment of the present invention, employs a random exploration method during training the detector 10 that deviates from the greedy policy with a positive probability η. For example, at each sample, a greedy action is chosen with probability 1−η and a random action is used with probability η. It will be appreciated that the need to provide random checks of the greedy function diminishes as confidence in the functions computed by the cost to go estimator 16 and cost of decision estimator 14 are developed. Accordingly, as learning becomes more established, the random tests may optionally be either reduced in frequency or eliminated. A method of random exploration according to another embodiment of the present invention increases the probability of the random action if the cost functions (cost-of-decision 26 and cost-to-go 27) are close in value.

The Detector Simulation

A simulation of the detector for a two-class (θ₀, θ₁) problem was constructed using three feedforward neural networks. The first network (posterior probability estimator network) was constructed with a single hidden layer network of ten neurons with ‘tanh’ activation functions, and was trained using the cross-entropy minimization method on the samples obtained from the reinforcement learning process to approximate the posterior probability for class θ₁. The second feedforward neural net (cost of decision estimator) was configured to compute a cost-of-decision function and the third feedforward neural network (cost to go estimator) was configured to compute a cost-to-go function. The second and third feedforward neural networks were trained with an on-policy Q-learning technique, and included random exploration of the probability space.

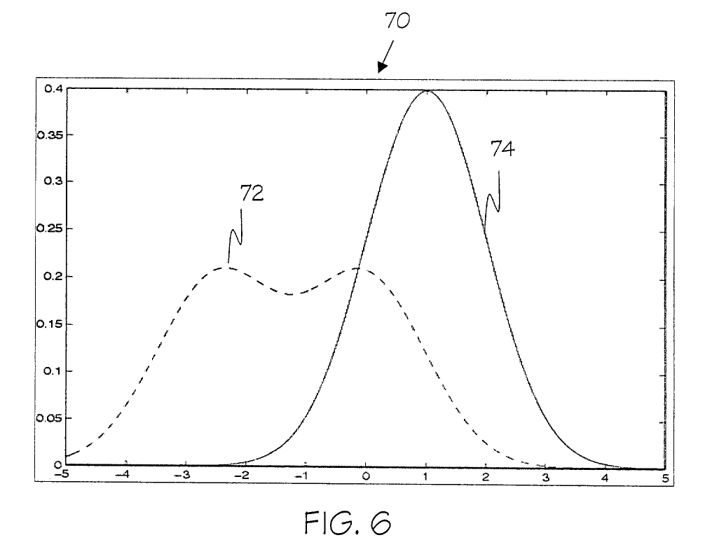

Class θ₀ was arbitrarily modeled based upon a Gaussian mixture distribution and class θ₁ was arbitrarily modeled based upon a single Gaussian distribution. Referring to FIG. 6, a graph 70 illustrates the probability density function for each class θ₀, θ₁. The Gaussian mixture is illustrated as a dashed curve 72, and the single Gaussian distribution is illustrated with solid lines 74. The priori probabilities were established as Prob(θ₀)=Prob(θ₁)=0.5. The cost for each sample was set to c=1. The loss functions were determined as L(0,0)=L(1,1)=0 and L(1,0)=L(0,1)=10.

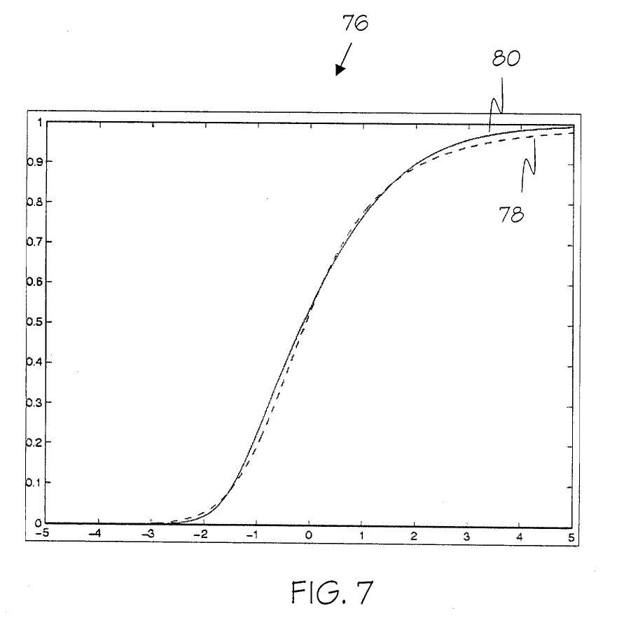

A posterior probability graph 76 for θ₁ is illustrated in FIG. 7. The posterior probability graph 7 represents data after 10,000 samples. The detector estimate is shown with a dashed curve 78. The true value for the posterior probability computed by optimal processes that knew a priori the respective distributions for the classes is given by the solid curve 80. It will be appreciated that the detector according to the various embodiments of the present invention can provide robust solutions irrespective of the underlying source statistics. For example, while the above example provides a comparison of the performance of the detector as compared to an optimal solution that uses a Gaussian mixture and a single Gaussian distribution, the detector provides robust solutions to problems irrespective of the underlying source statistics and irrespective of how complicated the distributions are to model. Further, the accumulations of log-likelihoods into logisitic outputs are robust to changes in the underlying statistics. Thus the various embodiments of the present invention are adaptive and can respond to changes in source statistics.

The cost-of-decision function computed by the second neural network, as well as the cost-to-go function computed by the third neural network were estimated using a Q-learning algorithm with random explorations. The parameters for the Q-learning process were set to γᵥ=0.01, γᵤ=0.001, and the exploration probability η=0.25. The respective cost functions were computed as:

U(πₖ,\hat{θ})=(1−γ_{U})U(πₖ,\hat{θ})+γ_{U}L(\hat{θ},θ)

V(πₖ)=(1−γ_{V})V(πₖ)+γ_{V} min{c+V(πₖ₊₁), U(πₖ₊₁,\hat{θ}*)}

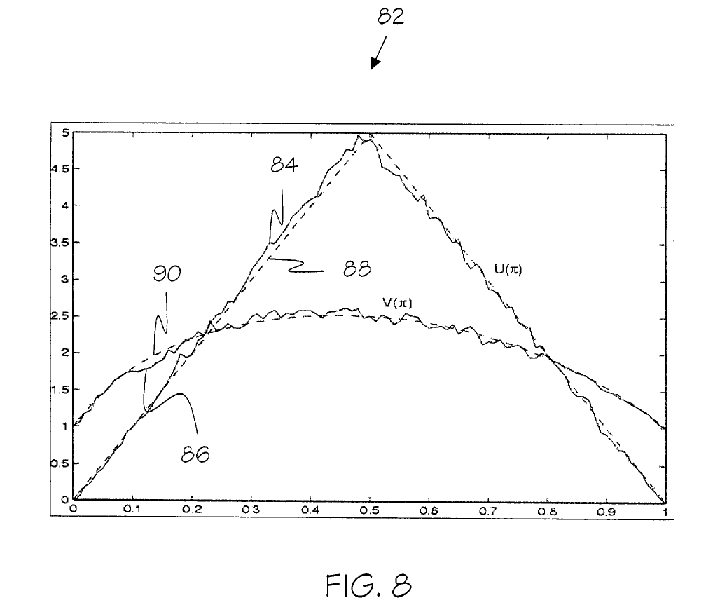

The cost function estimates for the above example are illustrated in FIG. 8. As shown, the solid curves 84, 86 represent optimal cost functions and the dashed curves 88, 90 represent cost functions predicted by the detector. The cost functions predicted by the detector converge to optimal cost functions at 100,000 samples. It will be appreciated however, that the detector achieves good results in significantly fewer samples than that required for convergence.

Table 1 illustrates a comparison of the detector performance at 10,000 samples and 100,000 samples as compared with an optimal sequential test where the conditional density functions were known to the optimal test.

TABLE 1

| Test | N | pₑᵣᵣₒᵣ | R |
|---|---|---|---|
| Neural Network at | 1.770 | 0.075 | 2.521 |
| 10,000 samples | | | |
| Neural Network at | 1.718 | 0.079 | 2.2517 |
| 100,000 samples | | | |
| Optimal Solution where | 1.763 | 0.075 | 2.513 |
| distributions were known | | | |

Table 1 demonstrates the average number of samples (N), the probability of error (pₑᵣᵣₒᵣe) and the average Bayes risk (R). The tests in Table 1 were conducted on separate data sets each having 1,000,000 samples. As the table shows, the detector very closely approximates optimal results with only 10,000 samples.

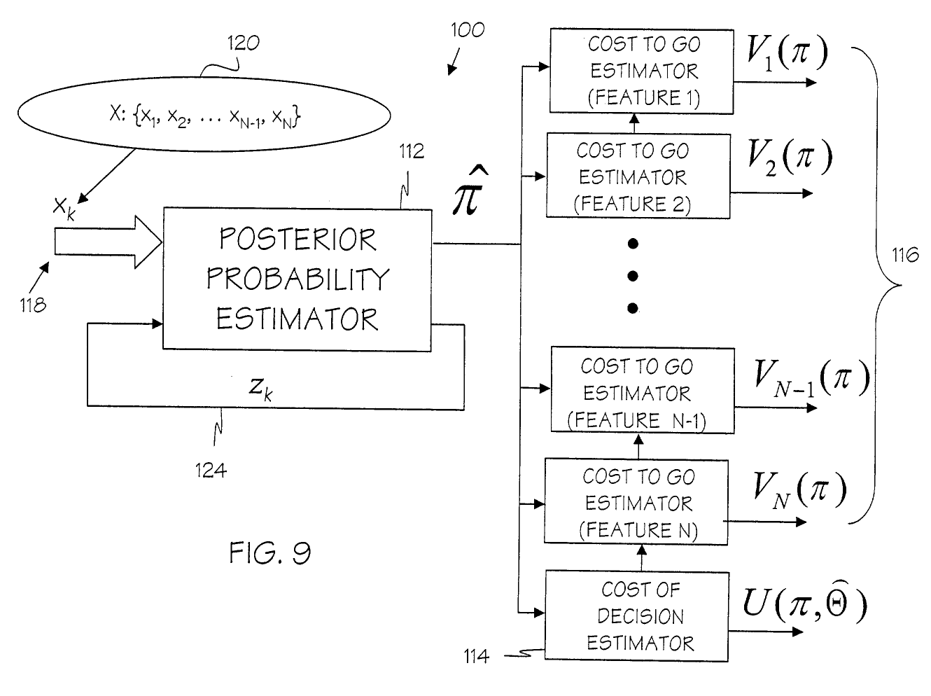

Referring to FIG. 9, a detector 100 is illustrated according to yet another embodiment of the present invention. The detector 100 is similar to detector illustrated in FIG. 1. As such, like structure is indicated with like reference numerals 100 higher in FIG. 9 over FIG. 1. It will be appreciated that unless otherwise noted, the discussions herein with respect to FIGS. 1-8 apply equally as well to FIG. 9. FIG. 9 provides a detector 100 suitable for feature selection applications. Accordingly, the detector 100 is adapted to select from different data streams to make classification decisions. As illustrated, a cost to go estimator 116 is provided for each feature 1−N. Each cost to go estimator 116 computes a cost to go function V_{N}(π) in a manner as more fully set out herein. As in the descriptions above, a Q-learning algorithm may be applied to each cost to go estimator 116 with random explorations. However, the random explorations are preferably extended to explore the beneficial regions of each feature. Also, the cost to go function of each feature may be calculated using a different weight value. The detector 100 sequentially continues to collect and process observations until a stopping criterion is met. For N features, that stopping criterion may be expressed by:

min(V(π₁), V(π₂) . . . V(π_{N-1}), V(π_{N}))>U(π,\hat{θ})

That is, the detector 100 explores the cost of pursuing each data stream associated with each of the cost to go estimators 116. The detector 100 decides the manner in which processing ensues until the stopping criterion is met. For example, the detector 100 can automatically decide on the order of sampling from the set of data streams realized by each of the cost to go estimators 116. The detector 100 can decide for example, to pursue the minimum cost to go data stream if the above stopping criterion formula is not satisfied.

Otherwise, the analysis and discussions provided above apply to the detector 100. For example, the detector 100 may be applied to multi-class (M classes) or two-class problems. For the multi-class problem, the resulting detector 100 comprises an M class by N feature sequential data acquisition system that can adapt to underlying source statistics of the data being tested. It will be appreciated that different networks may be required to approximate log likelihood determinations for each feature. The soft-max function and accumulation of the likelihoods will fuse the information supplied by each of the different features however. It will be appreciated that when constructing an M×N detector 100, suitable adjustments to boundary decisions and other parameters may be required.

Having described the invention in detail and by reference to preferred embodiments thereof, it will be apparent that modifications and variations are possible without departing from the scope of the invention defined in the appended claims.

What is claimed is:

1. A method of computing a posterior probability estimate for a sequential detector system comprising:
selecting samples of a data set sequentially, wherein each selected sample is processed comprising:
performing a likelihood computation based upon said sample;
accumulating said likelihood computation with likelihood computations from previously processed samples; and,
computing said posterior probability estimate based upon the accumulation of said likelihood computations.

2. The method of computing a posterior probability estimate for a sequential detector system according to claim 1, wherein said posterior probability estimate defines a measure of the likelihood that a source phenomenon of interest being tested belongs to a particular class.

3. The method of computing a posterior probability estimate for a sequential detector system according to claim 1, wherein said posterior probability estimate is used to discriminate between at least two classes.

4. The method of computing a posterior probability estimate for a sequential detector system according to claim 1, wherein said posterior probability estimate is used to perform a feature selection.

5. The method of computing a posterior probability estimate for a sequential detector system according to claim 1, wherein said likelihood computation is expressed as zₖ and the accumulation of said likelihood computations is expressed as Σ
$${\sum }_{k = 1}^{N} {z}_{k} ,$$
where N represents the total number of said plurality of samples.

6. The method of computing a posterior probability estimate for a sequential detector system according to claim 1, wherein said posterior probability estimate is computed by implementing a neural network configured to approximate Bayes optimal discriminant functions.

7. The method of computing a posterior probability estimate for a sequential detector system according to claim 1, wherein said posterior probability estimate is computed by constructing a first neural network implemented as a feedforward neural network having at least one input, at least one hidden layer that utilizes a hyperbolic tangent activation, and an output.

8. The method of computing a posterior probability estimate for a sequential detector system according to claim 1, wherein said posterior probability estimate is computed by constructing a first neural network comprising accumulating said likelihood computations into a linear output and transforming said linear output into a sigmoid output.

9. The method of computing a posterior probability estimate for a sequential detector system according to claim 1, wherein said posterior probability estimate is denoted \hat{π} and is given by the formula
$${\hat{π}}_{i} = \frac{{ⅇ}^{\sum {z}_{k}^{i}}}{1 + {\sum }_{m = 1}^{M - 1} {ⅇ}^{\sum {z}_{k}^{m}}} ,$$
where N represents the number of samples, and each likelihood is expressed as zₖ.

10. The method of computing a posterior probability estimate for a sequential detector system according to claim 1, wherein each likelihood computation comprises a log-likelihood computation expressed as
$${z}_{k}^{m} = {g}^{m} ( {x}_{k} ) \approx log ( \frac{f ( {x}_{k} \vert {θ}_{m} )}{f ( {x}_{k} \vert {θ}_{0} )} )$$
where the variable zₖ^{m} represents the output of the m'th network that approximates the log-likelihood of the m'th class.

11. The method of computing a posterior probability estimate for a sequential detector system according to claim 10, wherein said log-likelihood computation is implemented as the natural log.

12. The method of computing a posterior probability estimate for a sequential detector system according to claim 1, wherein said posterior probability estimate accounts for a prior bias in the source data by expressing said posterior probability estimate as a soft-max function based upon the accumulation of said likelihood computations.

13. The method of computing a posterior probability estimate for a sequential detector system according to claim 1, wherein said posterior probability estimate is denoted \hat{π} and is given by the formula
$$\hat{π} = \frac{L {ⅇ}^{{\sum }_{k = 1}^{N} {z}_{k} - N log L}}{1 + L {ⅇ}^{{\sum }_{k = 1}^{N} {z}_{k} - N log L}} ,$$
where N represents the number of samples, the a priori probability of class θ₁ is p, L=p/(1−p), and each likelihood is expressed as zₖ.

14. A method of performing adaptive sequential data analysis on a labeled data set comprising:
sequentially accessing a labeled data sample from said labeled data set;
computing for each labeled data sample, a posterior probability estimate comprising:
performing a likelihood computation for said labeled data sample;
accumulating said likelihood computation with likelihood computations from previously considered samples; and
computing said posterior probability estimate based upon the accumulation of likelihood computations;
determining a first cost associated with making a classification decision in view of the risk of an error in classification given said posterior probability estimate;
determining a second cost associated with collecting another labeled data sample before making a classification decision, said second cost based at least in part upon said posterior probability estimate;
comparing said first and second costs against a predetermined stopping criterion;
automatically repeating each of the above steps if the results of the comparison suggest taking another labeled data sample; and
performing a predetermined action if the results of the comparison suggest stopping.

15. The method of performing adaptive sequential data analysis according to claim 14, wherein said first cost is denoted U(π,\hat{θ}), and is expressed by U(πₖ,\hat{θ})=(1−γ_{U})U(πₖ,\hat{θ})+γ_{U}L(\hat{θ},θ) where L(\hat{θ},θ) denotes a loss function and the term γᵤ is a measure of how fast the sequential data analysis process is trying to learn as compared with the amount of information already learned.

16. The method of performing adaptive sequential data analysis according to claim 14, wherein said first cost is expressed as the expected decision cost of deciding in favor of a specific class given a specific value for said posterior probability estimate.

17. The method of performing adaptive sequential data analysis according to claim 14, wherein said first cost is computed by multiplying a probability that the sequential data analysis process will improperly classify the data by a weighting factor.

18. The method of performing adaptive sequential data analysis according to claim 14, wherein said first cost is determined by a neural network operating as a universal approximator, said neural network designed using a reinforcement learning algorithm that implements an on-policy version of the Q-learning algorithm.

19. The method of performing adaptive sequential data analysis according to claim 14, wherein said second cost is denoted V(π) and is expressed by V(πₖ)=(1−γ_{V})V(πₖ)+γ_{V} min{c+V(πₖ₊₁),U(πₖ₊₁,\hat{θ}*)}.

20. The method of performing adaptive sequential data analysis according to claim 14, wherein said second cost is determined by a neural network operating as a universal approximator, said neural network designed using a reinforcement learning algorithm that implements an on-policy version of the Q-learning algorithm.

21. The method of performing adaptive sequential data analysis according to claim 14, wherein a decision is made to stop sampling and make a classification decision when said second cost is greater than said first cost.

22. The method of performing adaptive sequential data analysis according to claim 14, wherein at least one of said first and second costs are updated when a decision is made to stop collecting samples and make a classification decision.

23. The method of performing adaptive sequential data analysis according to claim 14, wherein said predetermined stopping criterion is determined by:
identifying a greedy function wherein said second cost is greater than said first cost, said greedy function representing a first stopping criterion;
occasionally selecting a random function to test the hypothesis that said greedy function made a good choice in representing said stopping criterion,
updating said first and second costs based upon said random function; and
using the updates to said first and second cost functions to determine the accurateness of said greedy function.

24. The method of performing adaptive sequential data analysis according to claim 14, wherein said predetermined stopping criterion is determined by:
identifying a greedy function wherein said second cost is greater than said first cost, said greedy function representing a first stopping criterion;
choosing a greedy action with probability 1−η;
employing a random exploration that deviates from the greedy policy with a positive probability η to test the hypothesis that said greedy policy made a good choice in representing said stopping criterion;
updating said first and second costs based upon said random exploration; and
using the updates to said first and second cost functions to determine the accurateness of said greedy function.

25. The method of performing adaptive sequential data analysis according to claim 24, wherein the probability of said random explorations to check the greedy policy diminishes as confidence in the first and second costs are developed and increases as the first and second costs close in value.

26. The method of performing adaptive sequential data analysis according to claim 14, wherein said posterior probability estimate is computed without reliance on a predetermined statistical distribution of said source phenomenon of interest.

27. The method of performing adaptive sequential data analysis according to claim 14, wherein said posterior probability estimate is determined for each sample by performing a likelihood computation.

28. The method of performing adaptive sequential data analysis according to claim 14, wherein said posterior probability estimate defines a conditional density function derived from an accumulation of said log-likelihoods.

29. A method of automatically making a decision on the order of sampling from a given set of data streams comprising:
sequentially accessing a labeled data sample;
computing a posterior probability for said labeled data sample;
determining a first cost associated with making a classification decision in view of the risk of an error in classification given said posterior probability for each feature of a plurality of features;
determining a second cost associated with collecting another labeled data sample before making a classification decision, said second cost based at least in part upon said posterior probability;
choosing a data stream by comparing at least two of said first costs associated with respective features and selecting one stream associated with a selected one of said features based upon the comparison of said at least two of said first costs;
comparing said first cost associated with said stream and said second cost against a predetermined stopping criterion;
automatically repeating each of the above steps if the results of the comparison suggest taking another labeled data sample; and
performing a predetermined action if the results of the comparison suggest stopping.

30. The method of automatically making a decision on the order of sampling according to claim 29, wherein said first cost associated with each of said plurality of features may be calculated using a different weight value.

31. The method of automatically making a decision on the order of sampling according to claim 29, wherein said predetermined stopping criterion is determined by:
min(V(π₁), V(π₂) . . . V(π_{N-1}), V(π_{N}))>U(π,\hat{θ}).

32. The method of automatically making a decision on the order of sampling according to claim 29, wherein said data stream is chosen by comparing said first costs associated with each of said plurality of features and selecting the data stream associated with the minimum one of said first costs.

33. The method of automatically making a decision on the order of sampling according to claim 29, wherein said posterior probability of each of said first costs is determined by a unique neural network.

34. The method of automatically making a decision on the order of sampling according to claim 29, wherein said posterior probability is determined by an accumulation of likelihoods without a need to comprehend underlying source statistics.

35. The method of automatically making a decision on the order of sampling according to claim 29, wherein a log-likelihood is computed for each feature.

36. The method of automatically making a decision on the order of sampling according to claim 35, wherein a soft-max function is used to fuse accumulations of each of said log-likelihood determinations.

37. A detector for sequential data analysis systems comprising:
a posterior probability estimator arranged to analyze samples from a data set in a sequential manner, and generate an estimated posterior probability based upon an accumulation of log-likelihood determinations computed for each sample considered.

38. The detector according to claim 37, wherein said accumulation of log-likelihoods defines a probability estimate that said sample belongs to a predetermined class.

39. The detector according to claim 37, wherein said accumulation of log-likelihoods defines a probability estimate that is used to perform a feature selection operation.

40. The detector according to claim 37, wherein each log-likelihood is expressed by the equation
$${z}_{k}^{m} = {g}^{m} ( {x}_{k} ) \approx log ( \frac{f ( {x}_{k} \vert {θ}_{m} )}{f ( {x}_{k} \vert {θ}_{0} )} ) .$$

41. The detector according to claim 37, wherein said accumulation of log-likelihoods is transformed into a conditional density distribution expressed by the equation:
$${\hat{π}}_{i} = \frac{{ⅇ}^{\sum {z}_{k}^{i}}}{1 + {\sum }_{m = 1}^{M - 1} {ⅇ}^{\sum {z}_{k}^{m}}} .$$

42. The detector according to claim 37, wherein said posterior probability estimator comprises a universal approximator having:
at least one input;
at least one nonlinear hidden layer that utilizes a hyperbolic tangent activation communicably coupled to said at least one input;
at least one linear output communicably coupled to said at least one hidden layer; and,
a logistic output communicably coupled to said at least one linear output arranged to transform an accumulation of linear output computations into at least one logistic output.

43. The detector according to claim 37, wherein said posterior probability estimate is denoted \hat{π} and is given by the formula
$$\hat{π} = \frac{{Le}^{{\sum }_{k = 1}^{N} {z}_{k} - N log L}}{1 + {Le}^{{\sum }_{k = 1}^{N} {z}_{k} - N log L}} ,$$
where N represents the number of samples, he a priori probability of class θ₁ is p, L=p/(1−p), and each likelihood is expressed as zₖ.

44. A detector for sequential data analysis systems comprising:
a posteriori probability estimator arranged to analyze labeled data samples sequentially and compute an estimated posterior probability by computing for each labeled data sample received, a probability that a source phenomenon of interest described by said labeled data samples belongs to a first class, said probability computed without reliance on a predetermined statistical distribution of said source phenomenon of interest.

45. An adaptive sequential data analysis system comprising:
a posterior probability estimator arranged to access a labeled data sample from a labeled data set sequentially and compute therefrom an estimated posterior probability, wherein said posterior probability estimator:
performs a likelihood computation for said labeled data sample;
accumulates said likelihood computation with likelihood computations from previously considered samples; and
computes said posterior probability based upon the accumulation of likelihood computations
a cost of decision estimator communicably coupled to said posterior probability estimator, said cost of decision estimator arranged to determine a first cost associated with making a classification decision in view of the risk of an error in classification given said posterior probability,
a cost to go estimator communicably coupled to said posterior probability estimator, said cost to go estimator arranged to determine a second cost associated with collecting another labeled data sample before making a classification decision, said second cost based at least in part upon said posterior probability; and,
a decision processor communicably coupled to said cost of decision estimator and said cost to go estimator, said decision processor arranged to compare said first and second costs against a predetermined stopping criterion, wherein said decision processor is configured to trigger a predetermined action based upon the comparison.

46. The adaptive sequential data analysis system according to claim 45, wherein said decision processor is configured to decide whether to collect another sample automatically based upon the comparison between said first and second costs.

47. The adaptive sequential data analysis system according to claim 45, wherein said cost of decision processor computes said first cost denoted U(π,\hat{θ}) by implementing the equation U(πₖ,\hat{θ})=(1−γ_{U})U(πₖ,\hat{θ})+γ_{U}L(\hat{θ}, θ) where L(\hat{θ}, θ) denotes a loss function and the term γᵤ is a measure of how fast the sequential data analysis process is trying to learn as compared with the amount of information already learned.

48. The adaptive sequential data analysis system according to claim 45, wherein said first cost is expressed as the expected decision cost of deciding in favor of a specific class given a specific value for said posterior probability.

49. The adaptive sequential data analysis system according to claim 45, wherein said cost of decision estimator is configured to compute said first cost by multiplying a probability that the sequential data analysis process will improperly classify the data by a weighting factor.

50. The adaptive sequential data analysis system according to claim 45, wherein said cost of decision estimator comprises a neural network operating as a universal approximator, said neural network designed using a reinforcement learning algorithm that implements an on-policy version of the Q-learning algorithm.

51. The adaptive sequential data analysis system according to claim 45, wherein said cost to go estimator computes said second cost, denoted V(π) and computed by implementing the equation V(πₖ)=(1−γ_{V})V(πₖ)+γ_{V} min{c+V(πₖ₊₁)U(πₖ₊₁,\hat{θ}*)}.

52. The adaptive sequential data analysis system according to claim 45, wherein said cost to go estimator comprises a neural network operating as a universal approximator, said neural network designed using a reinforcement learning algorithm that implements an on-policy version of the Q-learning algorithm.

53. The adaptive sequential data analysis system according to claim 45, wherein said decision processor is configured to stop sampling and make a classification decision when said second cost is greater than said first cost.

54. The adaptive sequential data analysis system according to claim 45, wherein the system is configured to update at least one of said first and second costs when said decision processor decides to stop collecting samples and make a classification decision.

55. The adaptive sequential data analysis system according to claim 45, wherein said decision processor is configured to:
identify a greedy function wherein said second cost is greater than said first cost, said greedy function representing a first stopping criterion;
occasionally select a random function to test the hypothesis that said greedy function made a good choice in representing said stopping criterion,
update said first and second costs based upon said random function; and
use the updates to said first and second cost functions to determine the accurateness of said greedy function, in order to determine said predetermined stopping criterion.

56. The adaptive sequential data analysis system according to claim 45, wherein said decision processor is configured to:
identify a greedy function wherein said second cost is greater than said first cost, said greedy function representing a first stopping criterion;
choose a greedy action with probability 1−η;
employ a random exploration that deviates from the greedy policy with a positive probability η to test the hypothesis that said greedy policy made a good choice in representing said stopping criterion;
update said first and second costs based upon said random exploration; and
use the updates to said first and second cost functions to determine the accurateness of said greedy function, in order to determine said stopping criterion.

57. The adaptive sequential data analysis system according to claim 56, wherein said decision processor is configured to diminish the probability of said random explorations to check the greedy policy as confidence in the first and second costs are developed.

58. The adaptive sequential data analysis system according to claim 56, wherein said decision processor is configured to increase the probability of said random explorations if the first and second costs are close in value.

59. The adaptive sequential data analysis system according to claim 45, wherein said posterior probability estimator is configured to compute said posterior probability without reliance on a predetermined statistical distribution of said source phenomenon of interest.

60. The adaptive sequential data analysis system according to claim 59, wherein said posterior probability estimator is configured to define said posterior probability as a conditional density function derived from an accumulation of said log-likelihoods.

61. A sequential detector capable of analyzing multiple streams comprising:
a posterior probability estimator arranged to access a labeled data set sequentially and compute therefrom an estimated posterior probability;
a plurality of cost of decision estimators each communicably coupled to said posterior probability estimator, each of said cost of decision estimators arranged to determine a first cost associated with making a classification decision in view of the risk of an error in classification given said posterior probability for a select one of a plurality of features;
a cost to go estimator communicably coupled to said posterior probability estimator, said cost to go estimator arranged to determine a second cost associated with collecting another labeled data sample before making a classification decision, said second cost based at least in part upon said posterior probability; and
a decision processor communicably coupled to each of said cost of decision estimators and said cost to go estimator, said decision processor arranged to:
choose a data stream by comparing at least two of said first costs associated with respective features and selecting one stream associated with a selected one of said features based upon the comparison of said at least two of said first costs; and
compare said first cost associated with said stream and said second cost against a predetermined stopping criterion.

62. The sequential detector according to claim 61, wherein said posterior probability estimator continues to collect new data samples sequentially until said predetermined stopping criterion is met.

63. The sequential detector according to claim 61, wherein each of said cost to go estimators compute said first cost associated with each of said plurality of features using a different weight value.

64. The sequential detector according to claim 61, wherein said decision processor is configured to determine said predetermined stopping criterion when the minimum one of said first costs is greater than said second cost.

65. The sequential detector according to claim 61, wherein said decision processor is configured to determine said predetermined stopping criterion according to the equation min(V(π₁), V(π₂) . . . V(π_{N-1}), V(π_{N}))>U(π,\hat{θ}).

66. The sequential detector according to claim 61, wherein decision processor is configured to select a data stream by comparing said first costs associated with each of said plurality of features and selecting the data stream associated with the minimum one of said first costs.

67. The sequential detector according to claim 61, wherein said posterior probability estimator comprises a plurality of neural networks, each neural network configured to compute the posterior probability for a respective feature.

68. The sequential detector according to claim 61, wherein said posterior probability estimator is configured to determine said posterior probability by an accumulation of likelihoods without a need to comprehend underlying source statistics.

69. The sequential detector according to claim 61, wherein said posterior probability estimator is configured to determine a log-likelihood for each feature.

70. The sequential detector according to claim 69, wherein said posterior probability estimator is configured to utilize a soft-max to fuse accumulations of each of said log-likelihood determinations.
